(19) United States
(12) Patent Application Publication
(10) Pub. No.: US 2007/0138204 A1
(43) Pub. Date: Jun. 21, 2007

(54) Applicator that is used to apply one or more materials to a surface

(75) Inventors: Fung-jou Chen, Appleton, WI (US); Jeffrey D. Lindsay, Appleton, WI (US); Paul R. Schmidt, Neenah, WI (US)

Correspondence Address: SCHWEGMAN, LUNDBERG, WOESSNER & KLUTH, P.A., P.O. BOX 2938, MINNEAPOLIS, MN, 55402, US

(73) Assignee: Kimberly-Clark Worldwide, Inc.

(21) Appl. No.: 11/300,855

(22) Filed: Dec. 15, 2005

(51) Int. Cl. B67D 5/60; B65D 35/00

(52) U.S. Cl. 222/145.1; 222/106

(57) ABSTRACT

In one example embodiment, the applicator includes a base that has a first section, a second section and a weakened section which is between the first and second sections. The applicator further includes a first bladder and a second bladder. The first bladder is connected to a first outlet and the second bladder is connected to a second outlet. The first and second bladders are positioned on one side of the base such that neither of the first and second bladders overlaps the weakened section of the base. The applicator further includes a first material that is stored within the first bladder and a second material that is stored within the second bladder. When the base is folded at the weakened section, the first and second sections of the base force the materials from the first and second bladders through the respective first and second outlets.

### FIELD

The present invention relates to an applicator, and in particular to an applicator that is used to apply one or materials to a surface.

### BACKGROUND

There are many circumstances where one or more materials need to be applied to a surface. As examples, materials are sometimes applied to a surface for use as cleaners, sealing agents, caulking agents, cosmetics and health care agents (among other uses).

A variety of different types of devices are commonly used to store a material and then apply the material to a surface. One of the drawbacks with many of these types of devices is that they are often large and cumbersome which makes them difficult to clean up and/or store after use.

There are some small disposable packets that are sometimes used to store a material and then apply a material to a surface. However, the design of most small disposable packets typically makes them unsuitable for use to adequately apply a material to a surface.

As an example, the relatively high viscosity of some materials which are commonly stored in such packets makes it is difficult to squeeze the material from the packet without creating a mess or using an excessively large force. In addition, another tool is typically required in order to adequately apply the material to a surface once it is removed from the packet.

### SUMMARY OF THE INVENTION

The present invention is an applicator that is able to store a material and then apply the material to a surface. The applicator is able to generate a force that causes the material to be expelled from the applicator even when the material has a relatively high viscosity. In addition, the applicator is able to apply the material to a surface without the use of another tool and in a manner that reduces the mess which is typically associated with applying a material to a surface.

In one example embodiment, the applicator includes a base that has a first section, a second section and a weakened section which is between the first and second sections. The applicator further includes a bladder that is positioned on one side of the base and a material that is stored within the bladder. The applicator further includes a dispensing member that is positioned on an opposite side of the base to the bladder such that when the base is folded at the weakened section, the first and second sections of the base force the material from the bladder into the dispensing member.

Once the material is forced into the dispensing member, the dispensing member may be used to apply the material to a surface. As the base is further folded to bring the first and second sections closer together, the first and second sections continue to exert a force on the bladder so that the material continues to be expelled from the bladder into the dispensing member.

It should be noted that the weakened section of the base may take a variety of forms. The operation of the applicator will depend in part on the type of weakened section that is included in the base. Depending on the configuration of the weakened section, the weakened section of the base may (i) only bend; (ii) partially fracture; (iii) partially fracture and bend; or (iv) completely fracture as the base is folded at the weakened section.

The applicator may further include one or more support layers that are attached to one (or both) sides of the base. The support layer(s) may buttress the base when the base is folded at the weakened section.

In another example embodiment, the applicator includes a base that has a first section, a second section and a weakened section which is between the first and second sections. The applicator further includes a bladder and an outlet that is connected to the bladder. The bladder is positioned on one side of the base such that the bladder does not overlap the weakened section of the base. The applicator further includes a material that is stored within the bladder such that when the base is folded at the weakened section, the first and second sections of the base force the material from the bladder through the outlet.

Depending on the configuration of the applicator, a portion of the outlet may fracture as the weakened section of the base is folded in order to provide an opening in the outlet for the material to travel through. In some embodiments, the outlet and/or bladder may further include a seal that ruptures as the first and second sections of the base apply a force to the bladder.

The outlet and/or the seal may have the ability to at least partially restrain the flow of the material from the bladder after some material has been dispensed from the applicator. As an example, the outlet and/or the seal may close when the base is moved back toward an unfolded position and the first and second sections are no longer applying a force to the bladder. The ability of the outlet and/or the seal to close when the base is moved back toward an unfolded position may allow any material that remains in the bladder to be stored for application at a later time.

In still another example embodiment, the applicator includes a base that has a first section, a second section and a weakened section which is between the first and second sections. The applicator further includes a first bladder and a second bladder. The first bladder has a first outlet and the second bladder has a second outlet. The first and second bladders are positioned on one side of the base such that neither of the first and second bladders overlaps the weakened section of the base.

The applicator further includes a first material that is stored within the first bladder and a second material that is stored within the second bladder. When the base is folded at the weakened section, the first and second sections of the base force the first and second materials through the respective outlets of the first and second bladders.

The first material may be the same as the second material or different from the second material. As an example, the first and second materials may chemically react with one another as they are applied to a surface.

Additional features of the invention will become apparent to those skilled in the art upon consideration of the following detailed description of illustrated embodiments exemplifying the best mode of carrying out the invention as presently perceived.

### BRIEF DESCRIPTION OF THE FIGURES

FIG. 1 illustrates a top view of an example applicator.

FIG. 2 illustrates a side view of the example applicator shown in FIG. 1.

FIG. 3 illustrates a side view where the applicator in FIG. 2 is dispensing a material.

FIG. 4 is a top view illustrating a portion of an example applicator where the weakened section of the base on the applicator has a sinusoidal shape.

FIG. 5 is a side view illustrating a portion of an example applicator where the weakened section of the base on the applicator includes a bevel.

FIG. 6 is a side view similar to FIG. 5 where the weakened section of the base includes a cutout.

FIG. 7 is a side view similar to FIG. 3 illustrating another example applicator.

FIG. 8 is a side view similar to FIGS. 3 and 7 illustrating another example applicator.

FIG. 9 illustrates a top view of another example applicator.

FIG. 10 illustrates a side view of the example applicator shown in FIG. 9.

FIG. 11 illustrates a side view where the applicator shown in FIG. 10 is dispensing a material.

FIG. 12 is a side view similar to FIG. 11 illustrating another example applicator.

FIG. 13 is a side view similar to FIG. 10 illustrating another example applicator.

FIG. 14 is a side view illustrating where the example applicator shown in FIG. 13 is folded.

FIG. 15 illustrates a top view of another example applicator.

FIG. 16 illustrates a side view of the example applicator shown in FIG. 15.

FIG. 17 illustrates a side view where the applicator shown in FIG. 15 is dispensing a material.

FIG. 18 is a side view similar to FIG. 17 illustrating another example applicator.

FIG. 19 is a side view similar to FIG. 17 illustrating another example applicator.

FIG. 20 illustrates a top view of another example applicator.

FIG. 21 illustrates a side view of the example applicator shown in FIG. 20.

### DETAILED DESCRIPTION

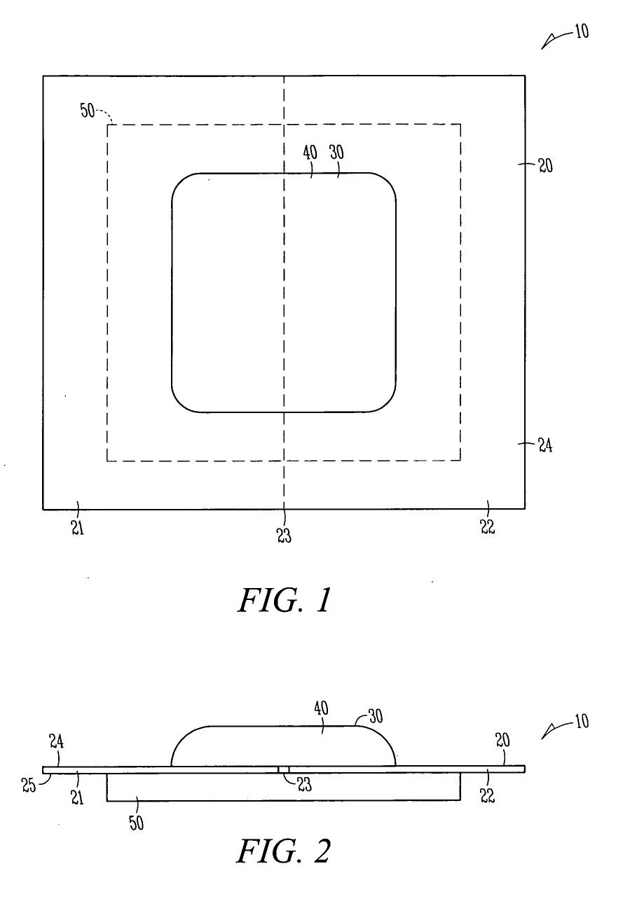

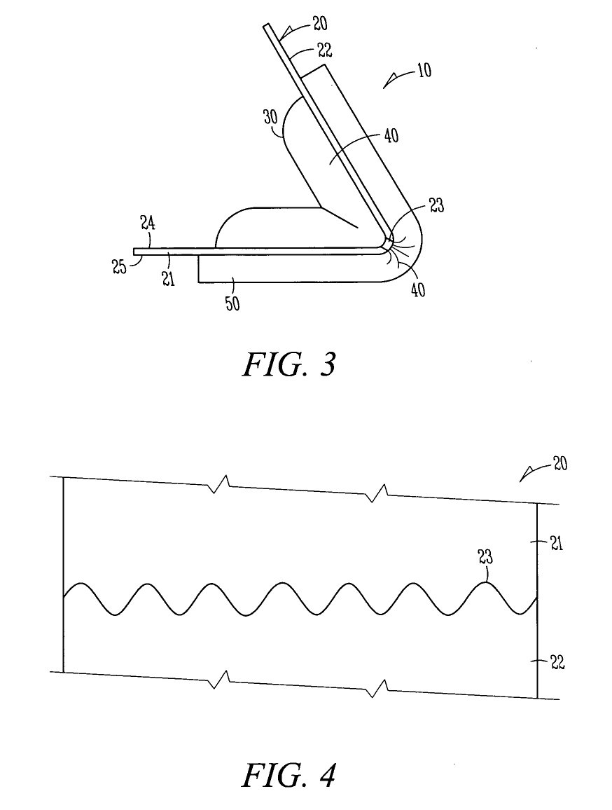

FIGS. 1-3 illustrate an example embodiment of an applicator 10. The applicator 10 includes a base 20 that has a first section 21, a second section 22 and a weakened section 23 which is between the first and second sections 21, 22. The applicator 10 further includes a bladder 30 that is positioned on one side 24 of the base 20 and a material 40 that is stored within the bladder 30. The applicator 10 further includes a dispensing member 50 that is positioned on an opposite side 25 of the base 20 to the bladder 30 such that when the base 20 is folded at the weakened section 23, the first and second sections 21, 22 force the material 40 from the bladder 30 into the dispensing member 50 (see FIG. 3).

Once the material 40 is forced into the dispensing member 50, the dispensing member 50 may be used to apply the material 40 to a surface (not shown). As the base is further folded to bring the first and second sections 21, 22 closer together, the first and second sections 21, 22 continue to exert a force on the bladder 30 so that the material 40 continues to be expelled from the bladder 30 into the dispensing member 50.

In some embodiments, the dispensing member 50 may be formed of a relatively flexible material that is able to spread the material 40 as the material 40 is applied to a surface. In other embodiments, the dispensing member 50 may be formed of a substantially rigid material such that the dispensing member 50 applies the material 40 to the surface in some semblance of a pattern. Some example materials that may be used for the dispensing member 50 include foams (e.g., melamine foam, polyurethane foam, regenerated cellulose, polyolefin foams, phenolic foams), nonwoven materials (e.g., meltblown, melt spun web, spun lace coform materials, bonded carded webs, air laid materials), textiles (e.g., woven cloth, felts, knits, netting), brush materials, paper-based materials (e.g., card stock, air laid, tissue). It should be noted that the dispensing member 50 may be laminates or composites of any of the above materials

It should be noted that the weakened section 23 of the base 20 may take a variety of forms. The operation of the applicator 10 will depend in part on the type of weakened section 23 that is included in the base 20. Depending on the configuration of the weakened section 23, the weakened section 23 of the base 20 may (i) only bend; (ii) partially fracture; (iii) partially fracture and bend; or (iv) completely fracture (see FIG. 3) as the base 20 is folded at the weakened section 23.

In the example embodiment that is illustrated in FIGS. 1-3, the first section 21 and the second section 22 of the base 20 have a substantially identical shape. It should be understood that first section 21 and the second section 22 may be different shapes and are not restricted to a particular size, shape and/or type.

In addition, FIGS. 1-3 illustrate that the weakened section 23 may be linear, while FIG. 4 shows a portion of an example applicator where the weakened section 23 has a sinusoidal shape. Depending on the configuration of the weakened section 23, the first section 21 may include an edge and the second section 22 may include an edge that are each formed as the base 20 is folded (see FIG. 3). As the material 40 is extruded from the bladder 30, the edges can be used to apply the material 30 to a surface. It should be noted that the bladder 30 may become narrower at an area where the material 40 is forced from the bladder 30 to promote efficient expulsion of the material 40 from the bladder 30.

As an example, the edges of the first and second sections 21, 22 may serve as tools for cleaning, scraping or abrading a surface and/or spreading the material onto the surface. In addition, the sinusoidal edges in FIG. 4 may be used to apply the material 40 to a surface in a series of streaks.

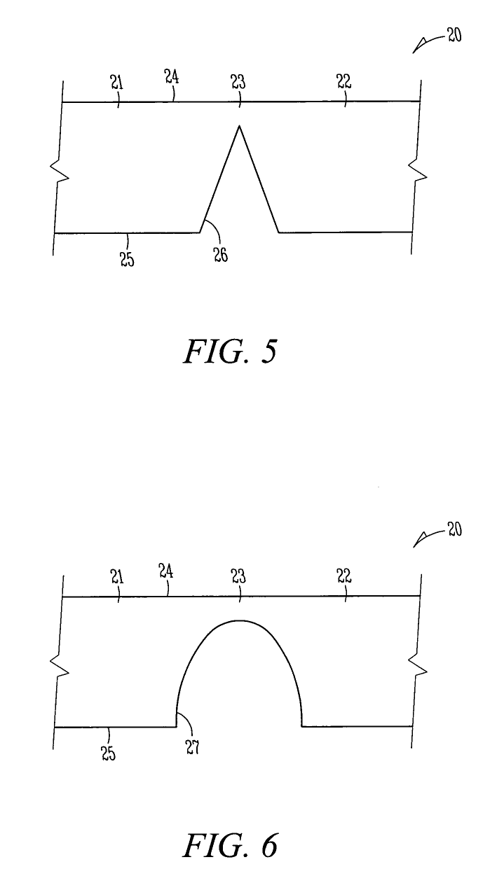

It is contemplated that the weakened section 23 may be any shape that permits the base 20 to be folded at the weakened section 23. As an example, FIGS. 5 and 6 show that the weakened section 23 of the base 20 may include a bevel 26 (FIG. 5) or a cutout 27 (FIG. 6) that facilitates folding (and sometimes fracturing) the base 20 at the weakened section 23. In some embodiments, the weakened section 23 of the base 20 may be thinner than the rest of the base 20.

The type of weakened section 23 that is included in the applicator 10 will depend in part on (i) the material which is used for the base 20; (ii) the types of materials 40 that are to be held by the bladder 30; (iii) the amount of material 40 that is to be applied to a surface; and (iv) the type of surface where the material is to be applied (among other factors).

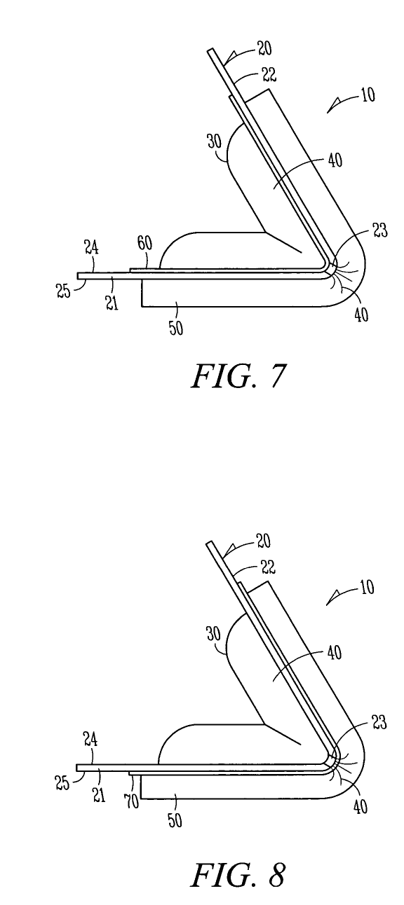

As shown in FIG. 7, the applicator 10 may further include a support layer 60 that attached to the base 20. In the example embodiment that is illustrated in FIG. 7, the support layer 60 is positioned on the same side 24 of the base 20 as the bladder 30. The support layer 60 may buttress the base 20 when the base 20 is folded at the weakened section 23.

As shown in FIG. 8, the applicator 10 may further include a support layer 70 that attached to the base 20. In the example embodiment that is illustrated in FIG. 7, the support layer 70 is between the base 20 and the dispensing member 50. The support layer 70 may be included on the applicator 10 in addition to support layer 60, or instead of support layer 60. The support provided by the support layer 60 and/or the support layer 70 may be especially important in those embodiments where the weakened section 23 of the base 20 completely fractures as the base 20 is folded.

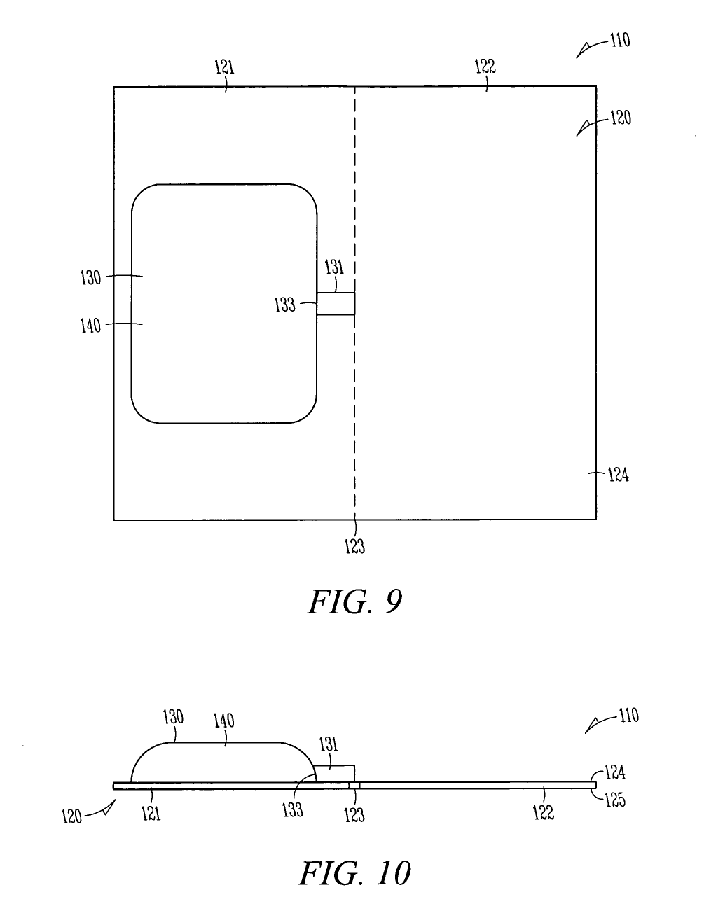

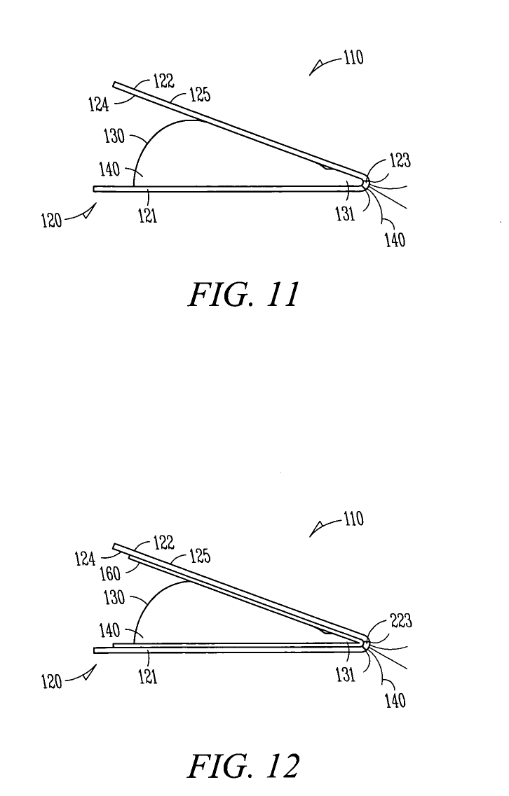

FIGS. 9-11 illustrate another example embodiment of an applicator 110. The applicator 110 includes a base 120 that has a first section 121, a second section 122 and a weakened section 123 which is between the first and second sections 121, 122.

The applicator 110 further includes a bladder 130 and an outlet 131 that is connected to the bladder 130. The bladder 130 is positioned on one side 124 of the base 120 such that the bladder 130 does not overlap the weakened section 123 of the base 120. The applicator 110 further includes a material 140 that is stored within the bladder 130 such that when the base 120 is folded at the weakened section 123, the first and second sections 121, 122 of the base 120 force the material 140 from the bladder 130 through the outlet 131. It should be noted that the base 120 may be similar to any of the bases 20 described above. In addition, the first, second and weakened sections 121, 122, 123 of the base 120 may be similar to any of the first, second and weakened sections 21, 22, 23 described above.

Depending on the configuration of the applicator 110, a portion of the outlet 131 may fracture as the weakened section 123 of the base 120 is folded in order to provide an opening in the outlet 131 for the material 140 to travel through. It should be noted that the applicator 110 may include multiple outlets (not shown). In addition, the outlet 131 may be elongated or have any other shape that permits the material 140 to be applied to a surface in a variety of cross-sectional shapes and sizes (e.g., a shape with a high width to height ratio).

In some embodiments, the outlet 131 and/or the bladder 130 may further include a seal 133 that ruptures as the first and second sections 121, 122 of the base 120 apply a force to the bladder 130. The seal 133 may be any type of seal 133 that is known now, or discovered in the future, as long as the seal 133 ruptures as the base 120 is folded.

In some embodiments, the outlet 131 and/or the seal 133 may have the ability to at least partially restrain the flow of the material 140 from the bladder 130 after some material 140 has been dispensed from the applicator 110. As an example, the outlet 131 and/or the seal 133 may close when the base 120 is moved back toward an unfolded position and the first and second sections 121, 122 are no longer applying a force to the bladder 130. The ability of the outlet 131 and/or the seal 133 to close when the base 120 is moved back toward an unfolded position may allow the material 140 that remains in the bladder 130 to be stored for application at a later time.

As shown in FIG. 12, the applicator 110 may further include a support layer 160 that is attached to the base 120. In the example embodiment that is illustrated in FIG. 12, the support layer 160 is positioned on the same side 124 of the base 120 as the bladder 130. The support layer 160 may buttress the base 120 when the base 120 is folded at the weakened section 123.

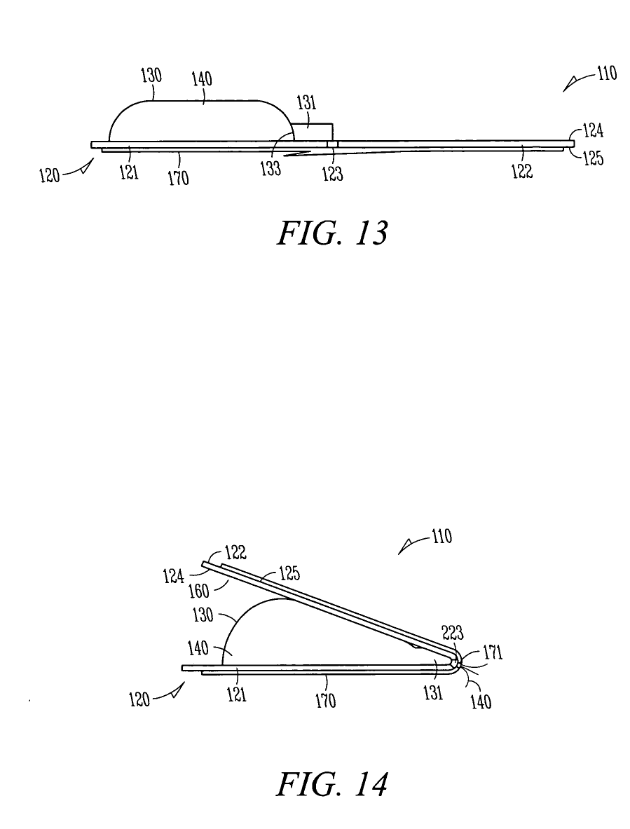

As shown in FIGS. 13-14, the applicator 110 may further include a support layer 170 that is attached to the base 120. In the example embodiment which is illustrated in FIGS. 13-14, the support layer 170 is positioned on an opposite side 125 of the base 120 to the bladder 130 such that the support layer 170 buttresses the base 120 when the base 120 is folded. The support layer 170 may be included on the applicator 110 in addition to support layer 160, or instead of support layer 160.

As shown in FIGS. 13 and 14, the support layer 170 may be provided with some slack so that the support layer 170 is extended as the base 120 is folded. The support layer 170 may also include openings 171 so that as the slack is reduced due to the folding of the base 120, the material 140 may be expelled through one or more of the openings 171 in the support layer 170.

In some embodiments, the openings 171 in the support layer 170 may serve as a way to control the flow of the material 140 from the applicator 110. The amount of material 140 that flows through the openings 171 will be determined in part by the size and placement of openings 171 in the support layer 170.

The support layers 160, 170 may be similar to any of the support layers 60, 70 described above. In addition, the support layers 160, 170 may be formed of the same material or different materials. It should be noted that a support layer which is similar to the support layer 170 may be included in any of the embodiments that are described or referenced herein.

Some example materials that may be used for the support layers in any of the embodiments that are described or referenced herein include mylar film, polypropylene film, nylon film, acrylic film, nonwoven web, paper web, foil layer, elastomeric layer (e.g., rubber, silicone, latex, neoprene), textile layer, foam layer (among other materials). It should be noted that the size, shape and type of supporting layers 160, 170 will depend in part on (i) the size and type of base 120; (ii) the type of material 140; (iii) the design of the outlet 131; and the size and type of bladder 130 (among other factors).

In some embodiments, the applicator 110 may further include a dispensing member (not shown) that is positioned on an opposite side 125 of the base 120 to the bladder 130. The dispensing member may be positioned such that when the base 120 is folded, the material 140 is forced through the outlet 131 into the dispensing member. The dispensing member may be similar to any of dispensing members 50 that are described or referenced above.

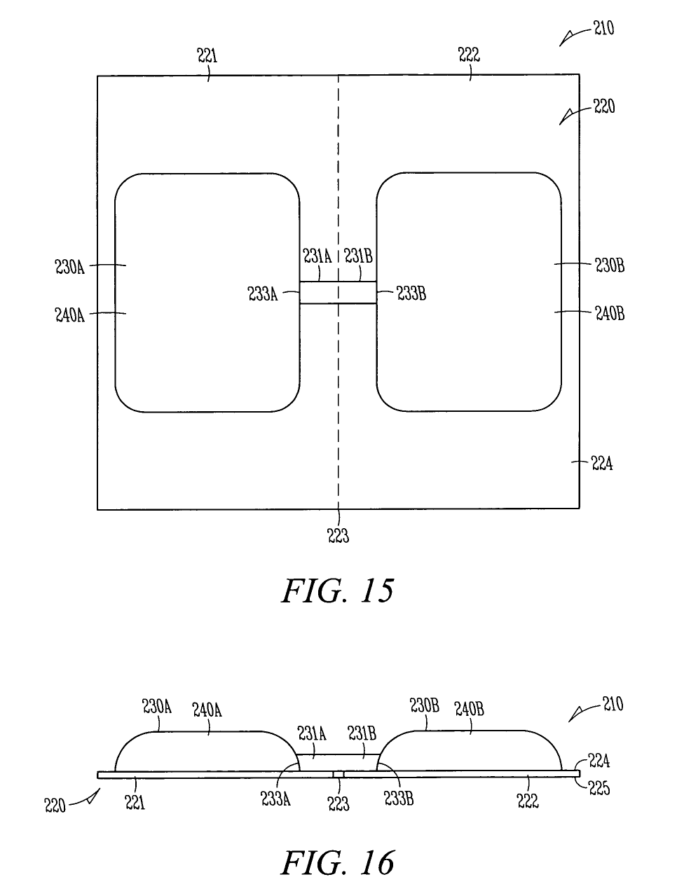

FIGS. 15-17 illustrate another example applicator 210. The applicator 210 includes a base 220 that has a first section 221, a second section 222 and a weakened section 223 which is between the first and second sections 221, 222. The applicator 210 further includes a first bladder 230A and a second bladder 230B. The first bladder 230A is connected to a first outlet 231A and the second bladder 230B is connected to a second outlet 231B. The first and second bladders 230A, 230B are positioned on one side 224 of the base 220 such that neither of the first and second bladders 230A, 230B overlaps the weakened section 223 of the base 220.

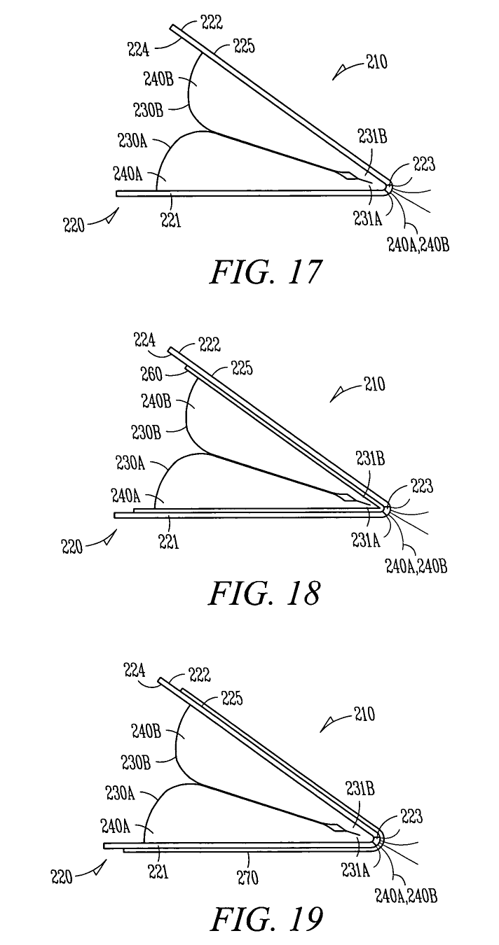

The applicator 210 further includes a first material 240A that is stored within the first bladder 230A and a second material 240B that is stored within the second bladder 230B. FIG. 17 shows that when the base 220 is folded at the weakened section 223, the first and second sections 221, 222 of the base 220 force the materials 240A, 240B from the first and second bladders 230A, 230B through the respective outlets 231A, 2311B.

In some embodiments, the first material 240A may be the same as the second material 240B. In other embodiments, the first material 240A may be different from the second material 240B. As an example, the first and second materials 240A, 240B may chemically react with one another as they are applied to a surface.

It should be noted that the base 220 may be similar to any of the bases 20, 120 described above. In addition, the first, second and weakened sections 221, 222, 223 of the base 220 may be similar to any of the first, second and weakened sections described above.

It should further be noted that the outlets 231A, 231B may be similar to any of the outlets 131 described above. In addition, each of the first and second outlets 231A, 231B and/or each of the first and second bladders 230A, 230B may include a respective seal 233A, 233B that is similar to any of the seals 133 described above.

FIG. 18 shows that the applicator 210 may further include a support layer 260 that is attached to the base 220. The support layer 260 is positioned on the same side 224 of the base 220 as the first and second bladders 230A, 230B to support the base 220 when the base 220 is folded.

FIG. 19 shows that the applicator 210 may further include a support layer 270 that attached to the base 220. The support layer 270 is positioned on an opposite side 225 of the base 220 as the first and second bladders 230A, 230B to support the base 220 when the base 220 is folded. The support layers 260, 270 may be similar to any of the support layers 60, 70, 160, 170 described above.

In some embodiments, the applicator 210 may further include a dispensing member (not shown) that is positioned on an opposite side 225 of the base 220 to the first and second bladders 230A, 230B. The dispensing member may be positioned such that when the base 220 is folded, the first and second sections 221, 222 of the base 220 force the first and second materials 240A, 240B from the first and second bladders 230A, 230B through the respective outlets 231A, 231B into the dispensing member. The dispensing member may be similar to any of dispensing members 50 that are described or referenced above.

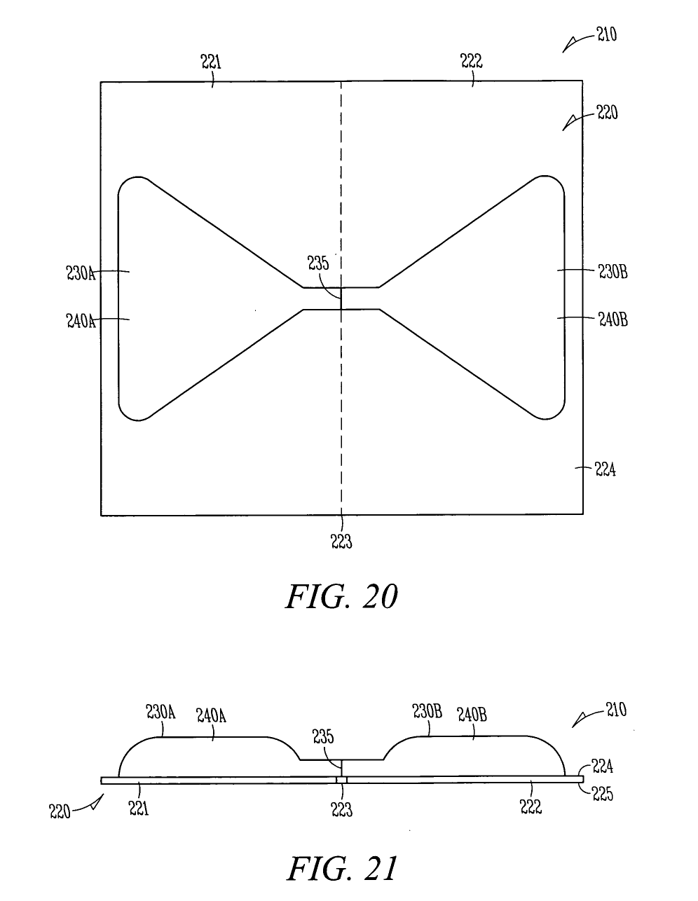

FIGS. 20 and 21 show an example embodiment of the applicator 210 where the first and second bladders 230A, 230B become narrower as the respective materials 240A, 240B are forced toward an outlet for the bladders 230A, 230B. The narrowing of the first and second bladders 230A, 230B may promote more efficient expulsion of the materials 240A, 240B from the first and second bladders 230A, 230B.

FIGS. 20 and 21 also show that in some embodiments, the first and bladders 230A, 230B may be separated by a seal 235 such that when the seal 235 is ruptured, the first and second materials 240A, 240B may be mixed prior to the base 220 being bent and/or broken. It should be noted that each of the materials 230A, 230B may not initially fill the respective bladders 240A, 240B so that there is room in each of the bladders 230A, 230B to permit mixing of the materials 240A, 240B within the bladders 230A, 230B. The first and second bladders 230A, 230B may also be made of an elastic material that permits each of the first and second bladders 230A, 230B to increase in size when the first and second materials 240A, 240B are mixed together within the first and second bladders 230A, 230B. The mixing of the materials 240A, 240B may be done successively depressing one bladder 230A and then the other bladder 230B to move the first and second materials 240A, 240B back and forth between the first and second bladders 230A, 230B.

The example applicators 10, 110, 210 that are described or referenced herein may be used to store a material, and then apply the material to a surface. Some example materials that may be incorporated into the applicators 10, 110, 210 include cosmetics (facial cream, foundation, lotion, skin health agent, shampoo, botanicals, hair conditioner, hair dye compounds), oral care components (toothpaste, breath freshener), adhesives, biological material (e.g., lactic acid producing bacteria), sealants, oxidizers, pharmaceutical agents, dyes (temporary, fugitive and permanent), indicator solutions (i.e., solutions that change color in response to a condition such as ph), caulks, cleaning agents, detergents, toilet agents, food products (peanut butter, cheese spread, jam, jelly, butter, honey, hummus spread, guacamole), skin health agents, skin sealants, coating agents, heating or cooling compositions (i.e., where the application of two components results in the subsequent release or absorption of heat) and odor control compositions (among others). Some other example materials are listed in U.S. Pat. No. 6,428,799. The materials that are stored in the bladder(s) may be a liquid, slurry, powder, gas and multiphase materials (among other flowable materials).

It should be noted that the base (e.g., bases 20, 120, 220 described above) may be formed of many different types of materials, or combinations of materials. The types of material that are selected for the base will depend in part whether it is desirable for the weakened section of the base to (i) only bend; (ii) partially fracture; (iii) partially fracture and bend: or (iv) completely as the base is folded at the weakened section. Some example materials that may be used for the bases that are described or referenced herein include acrylics, phenolics, polyolefins, polyamides, polystyrene, natural materials (e.g., wood and metal), PVC and laminates or composites of various materials (among other materials).

Although the invention has been described in detail with reference to certain illustrated embodiments, variations and modifications exist within the scope and spirit of the present invention as defined in the following claims.

What is claimed:

1. An applicator comprising:
a base that includes a first section, a second section and a weakened section between the first and second sections;
a bladder positioned on one side of the base;
a material stored within the bladder; and
a dispensing member positioned on an opposite side of the base to the bladder such that when the base is folded at the weakened section the first and second sections of the base force the material from the bladder into the dispensing member.

2. The applicator of claim 1, wherein the applicator is formed of foam.

3. The applicator of claim 1, wherein at least a portion of the weakened section on the base fractures as the base is folded.

4. The applicator of claim 3, wherein the weakened section of the base completely fractures as the base is folded.

5. The applicator of claim 1, wherein the weakened section of the base is substantially linear.

6. The applicator of claim 1, wherein the weakened section of the base has a sinusoidal shape.

7. The applicator of claim 1, wherein the first and second sections of the base have a substantially identical shape.

8. The applicator of claim 1, wherein the material is a liquid.

9. The applicator of claim 1, further comprising a support layer attached to the base, the support layer being positioned on the same side of the base as the bladder to support the base when the base is folded.

10. The applicator of claim 1, further comprising a support layer attached to the base, the support layer being positioned between the base and the dispensing member to support the base when the base is folded.

11. The applicator of claim 1, wherein the bladder becomes narrower at an area where the material is forced from the bladder to promote efficient expulsion of the material from the bladder.

12. An applicator comprising:
a base that includes a first section, a second section and a weakened section between the first and second sections;
a bladder that is positioned on one side of the base such that the bladder does not overlap the weakened section of the base;
an outlet that is connected to the bladder; and
a material stored within the bladder such that when the base is folded at the weakened section the first and second sections of the base force the material from the bladder through the outlet.

13. The applicator of claim 12, wherein at least one of the outlet and the bladder includes a seal that ruptures as the first and second sections of the base apply a force to the bladder.

14. The applicator of claim 13, wherein the outlet is able to at least partially restrain the flow of the material from the bladder when the first and second sections stop applying a force to the bladder.

15. The applicator of claim 12, wherein at least a portion of the weakened section on the base fractures as the base is folded.

16. The applicator of claim 15, wherein the weakened section of the base completely fractures as the base is folded.

17. The applicator of claim 12, wherein the weakened section of the base is substantially linear.

18. The applicator of claim 12, wherein the weakened section of the base has a sinusoidal shape.

19. The applicator of claim 12, wherein a portion of the outlet fractures as the weakened section of the base fractures in order to provide an opening in the outlet for the material to travel through.

20. The applicator of claim 12, wherein the material is a liquid

21. The applicator of claim 12, further comprising a support layer attached to the base, the support layer being positioned on the same side of the base as the bladder to support the base when the base is folded.

22. The applicator of claim 12, further comprising a support layer attached to the base, the support layer being positioned on an opposite side of the base as the bladder to support the base when the base is folded.

23. The applicator of claim 12, further comprising a dispensing member positioned on an opposite side of the base to the bladder such that when a sufficient force is applied to the base in order to fracture the weakened section the material is forced through the outlet into the dispensing member.

24. The applicator of claim 23, wherein the dispensing member is formed of foam.

25. The applicator of claim 12, wherein the bladder becomes narrower at the outlet to promote efficient expulsion of the material from the bladder.

26. An applicator comprising:
a base that includes a first section, a second section and a weakened section between the first and second sections;
a first bladder that is positioned on one side of the base such that the bladder is on the first section of the base and does not overlap the weakened section of the base;
a first outlet that is connected to the first bladder;
a second bladder that is positioned on the same side of the base as the first bladder such that the second bladder is on the second section of the base and does not overlap the weakened section of the base;
a second outlet that is connected to the second bladder;
a first material stored within the first bladder; and
a second material stored within the second bladder such that when the base is folded at the weakened section the first and second sections of the base force the material through the respective first and second outlets of the first and second bladders.

27. The applicator of claim 26, wherein at least one of the first and second outlets and the first and second bladders each include a seal that ruptures when the first and second sections of the base force the material through the respective first and second outlets of the first and second bladders.

28. The applicator of claim 26, wherein the weakened section on the base completely fractures as the base is folded.

29. The applicator of claim 26, wherein the weakened section of the base has a sinusoidal shape.

30. The applicator of claim 26, wherein a portion of each of the first and second outlets fractures as the base is folded in order to provide an opening in each of the first and second outlets for the first and second materials to travel through.

31. The applicator of claim 26, further comprising a support layer attached to the base, the support layer being positioned on the same side of the base as the bladder to support the base when the base is folded.

32. The applicator of claim 26, further comprising a support layer attached to the base, the support layer being positioned on an opposite side of the base to the first and second bladders to support the base when the base is folded.

33. The applicator of claim 26, further comprising a dispensing member positioned on an opposite side of the base to the first and second bladders such that when the base is folded the material is forced from the first and second bladders through each of the respective first and second outlets into the dispensing member.

34. The applicator of claim 26, wherein the first material is different than the second material.

35. The applicator of claim 26, wherein the first bladder becomes narrower as the first material is forced toward the first outlet to promote efficient expulsion of the first material from the first bladder, and the second bladder becomes narrower as the second material is forced toward the second outlet to promote efficient expulsion of the second material from the second bladder.

36. The applicator of claim 26, further comprising a seal that is between the first and second outlets, the seal being positioned such that when a force is applied to one of the first and second bladders to rupture the seal, one of the first and second materials is expelled into the other of the first and second bladders.

37. The applicator of claim 36, wherein each of the first and second materials do not fill the respective first and second bladders so that there is room in each of the first and second bladders to permit mixing of the first and second materials within the first and second bladders.
